(19) United States
(12) Patent Application Publication
(10) Pub. No.: US 2008/0297907 A1
(43) Pub. Date: Dec. 4, 2008

(54) Seamless molded reflectant material

(76) Inventors: Randall Howe, Eaton, CO (US); John Hunt, Westminster, CO (US); Rod Stillman, Greeley, CO (US)

Correspondence Address: EMERY L. TRACY, P.O. BOX 1518, BOULDER, CO, 80306, US

(21) Appl. No.: 12/082,282

(22) Filed: Apr. 10, 2008

Related U.S. Application Data
(60) Provisional application No. 60/922,968, filed on Apr. 11, 2007.

(51) Int. Cl. G02B 5/02; B29D 11/00; G02B 5/08

(52) U.S. Cl. 359/599; 264/1.1; 359/838

(57) ABSTRACT

A reflector device for reflecting light from an LED and the like is provided. The reflector device comprises a reflectant material and a three-dimensional reflector formed from the reflectant material with the reflector having a top and a base and the reflector being entirely free from seams from the top to the base.

The present application claims benefit of priority of pending provisional patent application Ser. No. 60/922,968, filed on Apr. 11, 2007, entitled “Molded Reflectant PET Material”.

### BACKGROUND OF THE INVENTION

1. Field of the Invention

This invention relates generally to a seamless molded reflectant material and, more particularly, the invention relates to a seamless molded reflectant material for molding a randomly disrupted surface reflectant material into seamless shapes for receiving light emitting diodes and other like light sources.

2. Description of the Prior Art

The optimization of diffuse lighting has benefited from the development of new generation plastic materials using new methods to produce very small-scale disrupted surfaces of highly reflective plastics. These materials include Dupont Optilon, W. L. Gore DSR, Furukawa MCPET, Sekisui Polyproplyene and others. The sheeted or rolled materials were initially advanced flat for 2D lighting applications such as CCFL backlights in LCD's, lighted graphic signs and fluorescent architectural lighting. As lighting sources and applications became more complex and required enhancement in shape, utility, and value, these new generation materials became limited by the following problems.

In the past, there have problems in optimizing surface reflectance in light reflecting applications:

1) Obtaining uniform 3D surfaces often required expensive secondary application processes and always leaves voids and seams from trimming and folding.
2) New generation materials are often created by disrupted surfaces of reflective plastic materials. The disruption in the surfaces can also make the new generation material air permeable or no longer useable in an air pressure or vacuum atmosphere to move or shape new generation materials into unitary geometric shapes.
3) Additionally, disrupted surfaces create highly diffuse reflective properties and can also resist absorption of the traditional heat sources required to soften or manipulate the new generation materials into unitary 3D seamless shapes.
4) In an attempt to solve some of these barriers, processors have used cutting, scoring, folding, and bending of new generation materials which require complex tooling, additional starting material thickness and surface area.
5) Other solutions to overcome shape manipulation have been lamination of the disrupted surface material to traditional substrates which accept atmospheres of vacuum and air pressure and sources of heat. This approach adds material costs as well as preliminary processing which can restrict the application of new generation reflective materials.
6) Reflectors can be subjected to extreme environmental shifts during operation and exposure. New generation materials produced in sheet or roll form carry built in bias or orientation from the sheet/roll extrusion process. Unless these materials are subjected to annealing levels of heat prior to final fitting and use, they are subject to dimensional changes referred to as shrinkage, creep, or expansion. All of these shifts can be very detrimental to specific tight tolerance requirements of reflective components in backlighting systems of LCD's or in architectural lighting systems.
7) Disrupted surfaces created for reflective materials create a byproduct of loss of temperature conduction through the addition of air mass, such as foaming, fiber layering, spin binding, or use of porous resin structures. This inherent insulative property creates heat and cooling problems for sensitive solid-state light sources such as LED's which, in turn, requires higher investment in temperature management systems within lighting systems. These management systems are traditionally accomplished separately from the reflective material rather than with 3D geometric shaping solutions.
8) Multiple light sources such as LED's have mounting tolerance issues that limit the precision of centerline accuracy over extended distances. These lights suffer reduced reflectance when gaps around the light source are increased. Semi-rigid new generation light reflectors with die cut apertures have a different centerline tolerance than the light sources which creates non-reflective gaps.
9) Attaching new generation reflectors to light sources or light housings traditionally require additional attachment features installed to the reflector, housing, or light source creating a more complex assembly. Other attempts, using die cut tabs or flaps require an additional pre installed bending step to create an interface.
10) Some applications have a desire to isolate multiple light sources into individual locations with barrier geometry. This has been accomplished in new generation reflective materials by cutting scoring and folding which adds processing, labor and material costs.
11) New generation reflective materials require a very disrupted surface to provide diffuse light reflection in the final state of application. Any adverse contact with the reflective surface that alters the reflective surface significantly devalues the reflective properties. This further limits the process or methods to manipulate new generation reflective materials into custom self-standing shapes.
12) Lighting assemblies are increasingly constrained to maximize use of space. Thickness of assembly components such as reflectors is required to facilitate this optimization. Some areas requiring reflectivity need to be thinner in some zones vs. others. Unitary wall thickness of sheet or roll stock is subject to the completed tolerance of the extrusion process.

### SUMMARY

The present invention is a reflector device for reflecting light from an LED and the like. The reflector device comprises a randomly disrrupted surface reflectant plastic material and a three-dimensional reflector formed from the reflectant material with the reflector having a top and a base and the reflector being entirely free from seams from the top to the base.

In addition, the present invention includes a method for reflecting light from an LED and the like. The method comprises providing a reflectant material and forming a seamless three-dimensional reflector from the reflectant material, the reflector having a top and a base.

The present invention further includes reflector device for reflecting light from an LED and the like. The reflector device comprises a reflectant material. A three-dimensional reflector is formed from the reflectant material with the reflector having a top and a base and being entirely free from seams from the top to the base. An aperture is formed in the base wherein the light source is receivable within the aperture.

### BRIEF DESCRIPTION OF THE DRAWINGS

FIG. 1 is a perspective view illustrating a seamless molded reflectant material, constructed in accordance with the present invention;

FIG. 2 is a top plan view illustrating the seamless molded reflectant material of FIG. 1, constructed in accordance with the present invention;

FIG. 3 is an elevational side view illustrating the seamless molded reflectant material of FIG. 1, constructed in accordance with the present invention;

FIG. 4 is another top plan view illustrating the seamless molded reflectant material of FIG. 1, constructed in accordance with the present invention;

FIG. 5 is still another top plan view illustrating the seamless molded reflectant material of FIG. 1, constructed in accordance with the present invention;

FIG. 6 is another elevational side view illustrating the seamless molded reflectant material of FIG. 1, constructed in accordance with the present invention;

FIG. 7 is an end view illustrating the seamless molded reflectant material of FIG. 1, constructed in accordance with the present invention;

FIG. 8 is a perspective view illustrating another embodiment of the seamless molded reflectant material, constructed in accordance with the present invention;

FIG. 9 is a perspective view illustrating still another embodiment of the seamless molded reflectant material, constructed in accordance with the present invention;

FIG. 10 is a perspective view illustrating a mold plate for the seamless molded reflectant material of FIG. 1, constructed in accordance with the present invention;

FIG. 11 is a perspective view illustrating a mold plate for the seamless molded reflectant material of FIGS. 9 and 10, constructed in accordance with the present invention;

FIG. 12 is a sectional side view illustrating a wave ring formed at a bottom of the seamless molded reflectant material, constructed in accordance with the present invention;

FIG. 13 is a sectional side view illustrating a lambertian emitter of the seamless molded reflectant material, constructed in accordance with the present invention;

FIG. 14 is a top plan view illustrating a mold for the seamless molded reflectant material, constructed in accordance with the present invention; and

FIG. 15 is a sectional view illustrating the mold for the seamless molded reflectant material of FIG. 14, constructed in accordance with the present invention.

### DETAILED DESCRIPTION OF THE PREFERRED EMBODIMENTS

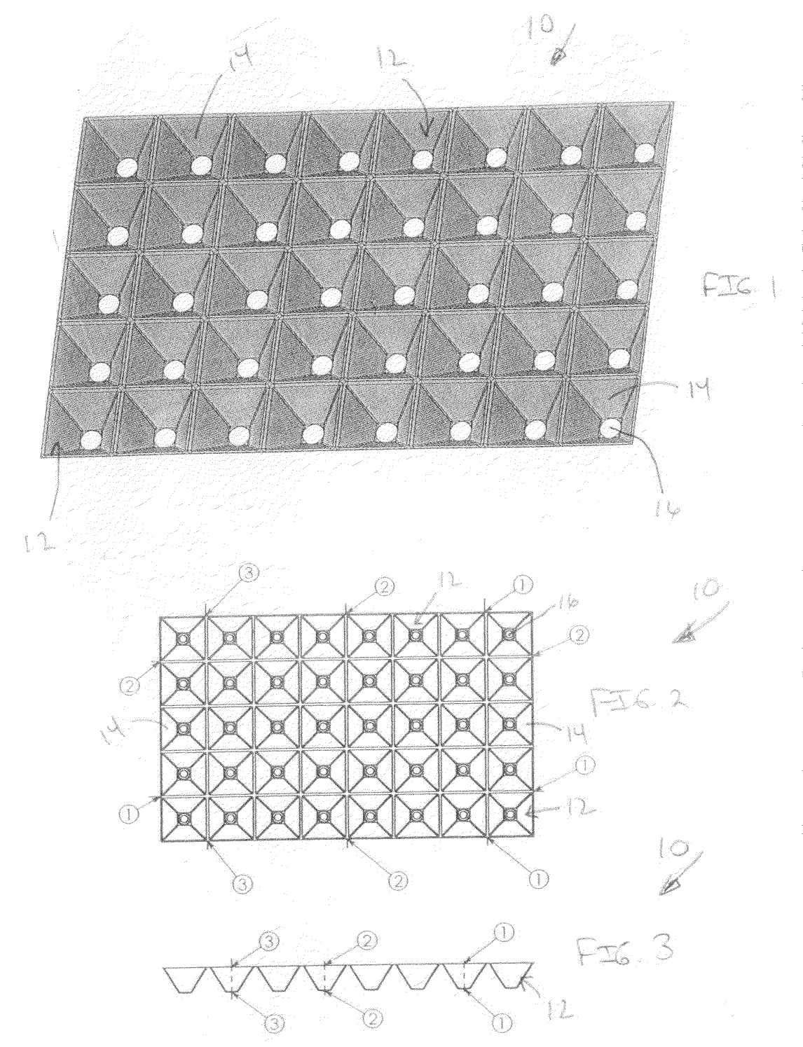

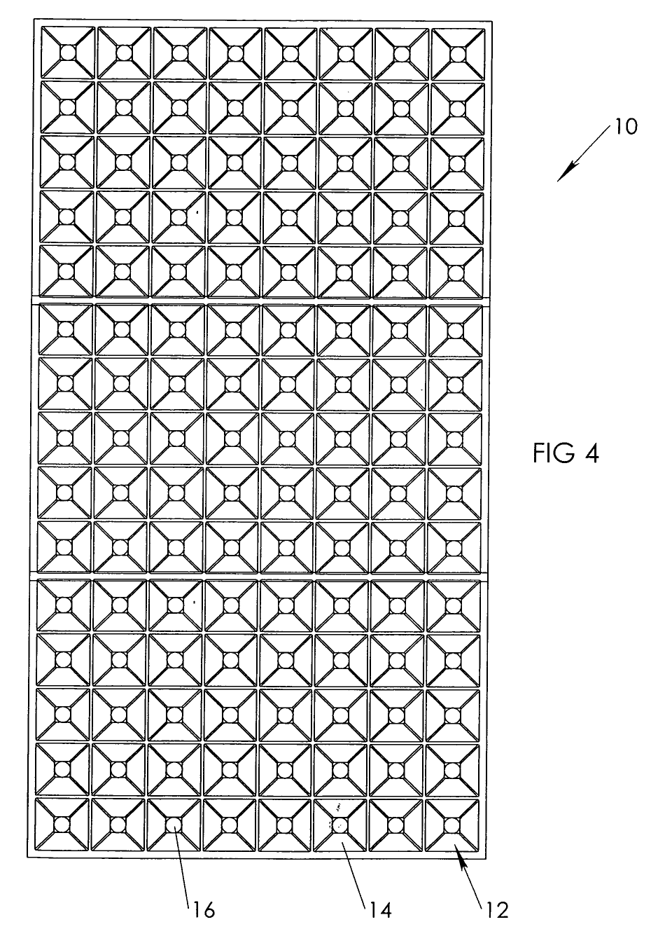

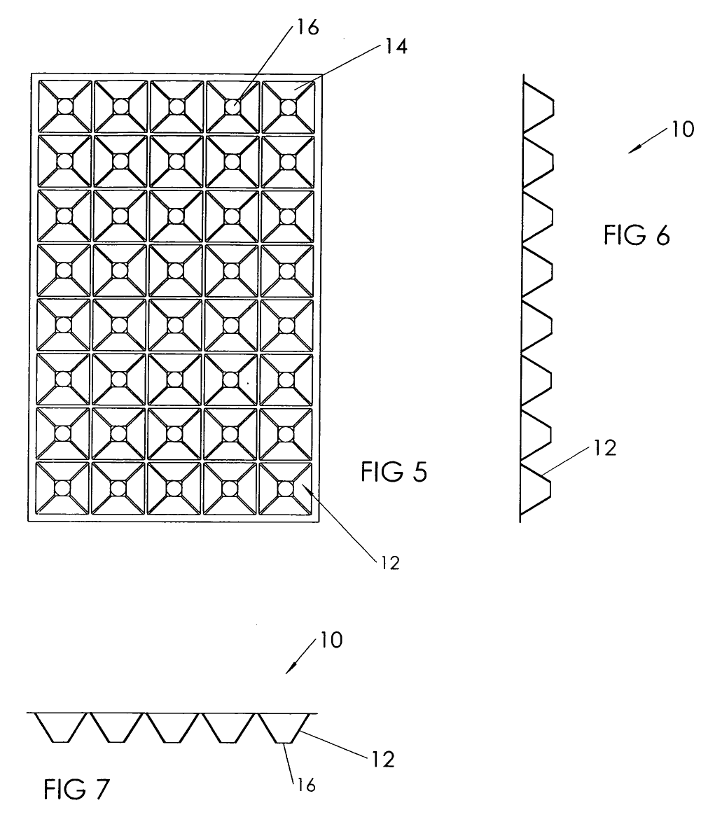

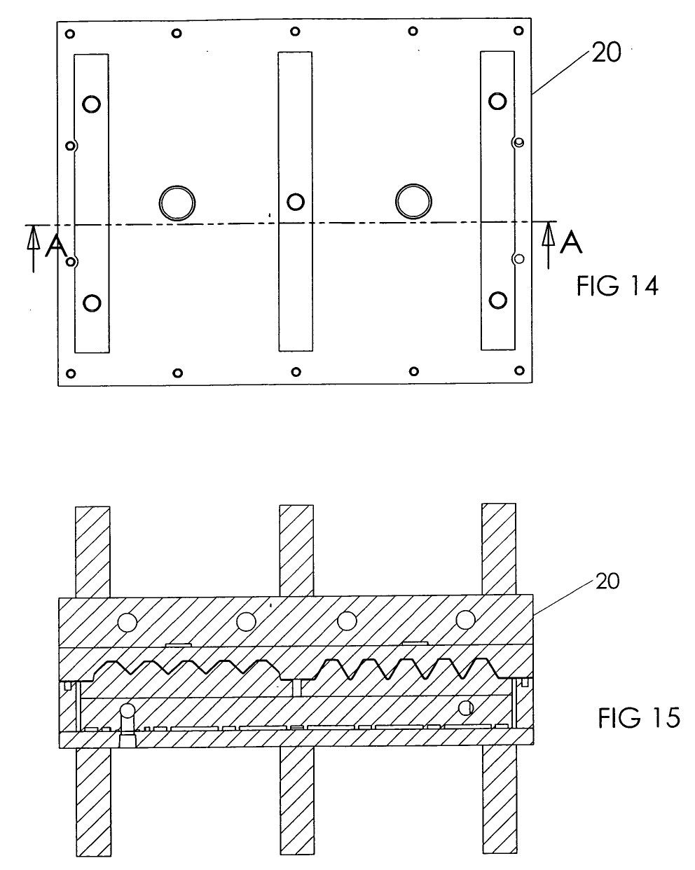

As illustrated in FIGS. 1-15, the present invention is seamless molded reflectant material 10 providing reflectors 12 with an uninterrupted reflective surface 14 thereby creating more reflectance as compared to conventional cut, folded, or sectional lamination (cut and paste). Basically, the unitary 3D shapes of the seamless reflectors of the present invention allow for self-standing or singular independent function of the unique reflector material. Not requiring backer or laminated support materials provides new 3D reflector design opportunities for unique reflector material applications.

Illustrated herein are three (3) different embodiments of the seamless molded reflectant material 10 of the present invention. As understood by those persons skilled in the art, the embodiments illustrated herein are examples of the reflector 12 shapes possible under the present invention and the present invention covers all reflectors 12 created from the seamless molded reflectant material 10 of the present invention.

As illustrated and described herein, the seamless molded reflectant material 10 is preferably a disrupted surface PET or PE material, for example forming a seamless three-dimensional shaped reflector 12 for receiving light emitting diodes and other light emitting sources. Preferably, the reflectant material 10 is a microcellular PET material although any type of reflectant material 10 is within the scope of the present invention.

In a first embodiment, as illustrated in FIGS. 1-7, the reflectors 12 formed with the seamless molded reflectant material 10 of the present invention are formed in a waffle-like configuration. The reflectors 10 are seamless and provide increased reflectance of light as compared to conventional cut, folded, or sectional lamination 7 methods.

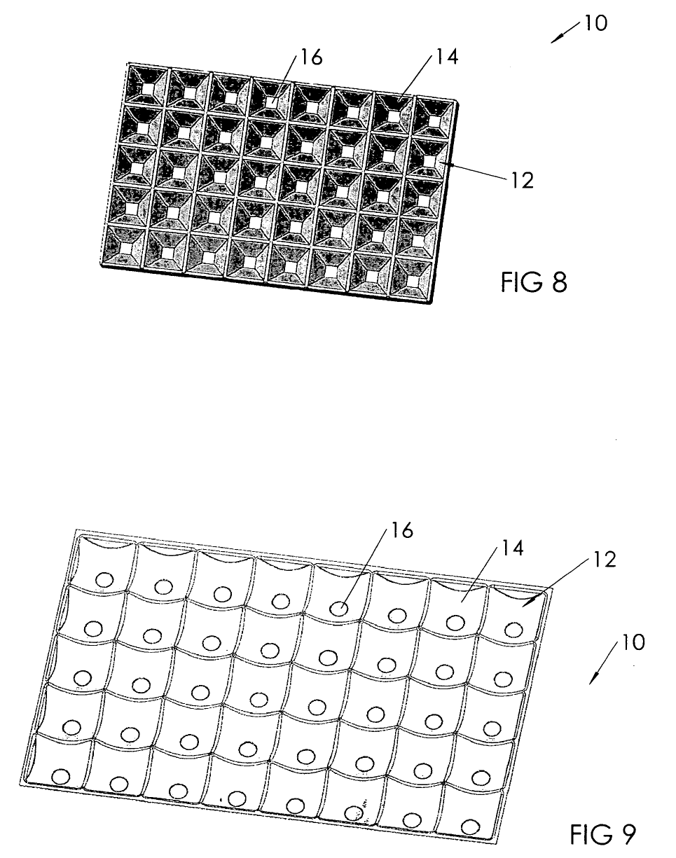

In a second embodiment, as illustrated in FIG. 8, a different shape reflector 12 is formed. In a third embodiment, as illustrated in FIG. 9, still a different shape reflector 12 is formed. Each of the reflectors 12 increase the light reflectance from the seamless reflective surfaces 14 as compared to conventional reflectors using the same material without the seamless reflective surfaces 14.

In all embodiments, the reflectors 12 of the seamless molded reflectant material 10 of the present invention are unitary 3D, self standing reflectors 12 minimizing shrinkage or creep of the unique reflector materials described above which are less stable in flat or planar conditions and subjected to increased levels of heat, cold, and moisture. This stabilization can be accomplished through geometric beam, angle, radii, and other stress management geometric shapes in the unique reflecting materials. An aperture 16 can be formed in the base of the reflector 12 for receiving the LED or other light-emitting source.

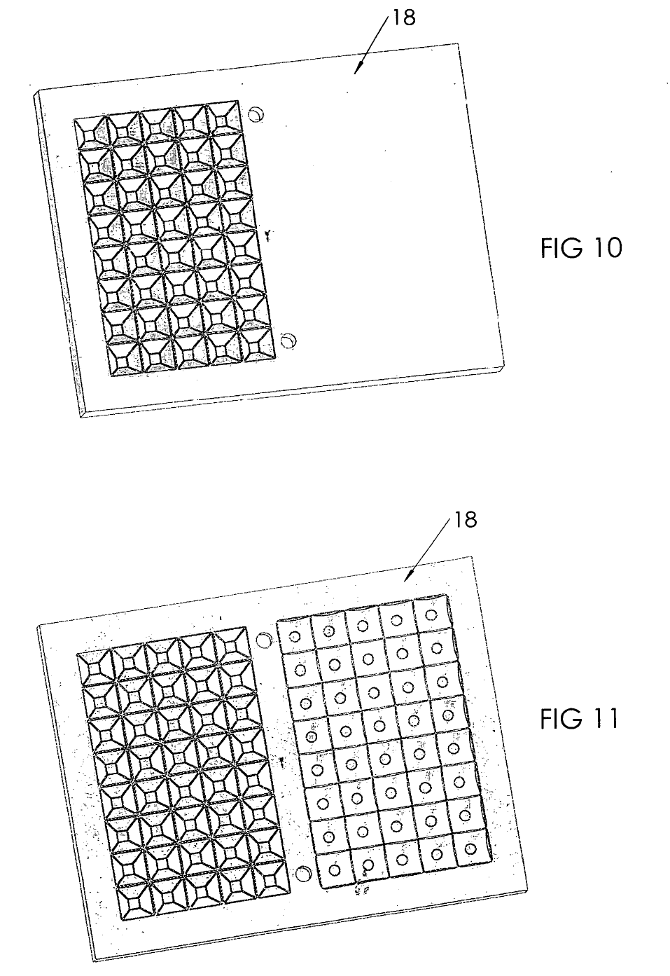

The seamless reflector 12 of the molded reflectant material 10 of the present invention can also be further stabilized through the unique shape generating process which includes exposure to temperatures sufficient to provide some levels of annealing to the unique reflector materials. As illustrated in FIGS. 10, 11, 14, and 16, the mold plates 18 and the mold 20 are shown which are able to form the particular reflector shapes. Elongating new generation reflective materials into continuous geometric shapes having a continuous reflective surface 14 requires less material than folding the same thickness material over all surfaces.

The seamless molded reflectant material 10 of the present invention economically produces isolation reflector cells 12 for single or multiple solid state and other light sources for custom light control systems such as IMLEDS (individually modulated LEDS). In a single process, a variable thickness, geometric tight tolerance, seamless reflector 12 can be made with a new hybrid process of molding, thermoforming, stamping and atmospheric combinations, and multiplanar trimming reducing or eliminating secondary processes. This process moves such surface reflector materials with minimal adverse effect to the diffuse reflectance of the material.

The self-standing geometric shaped reflectors 12 can now be combined with formed laminations of divergent geometric shapes for added function and value for lighting applications such as attachment, airflow, temperature management, supporting component space allowance, and others. Some geometric shapes create adjustable pressure or stress absorption preserving light seal areas around light components. Furthermore, self-standing geometric features can be used for attachment to other assembly components.

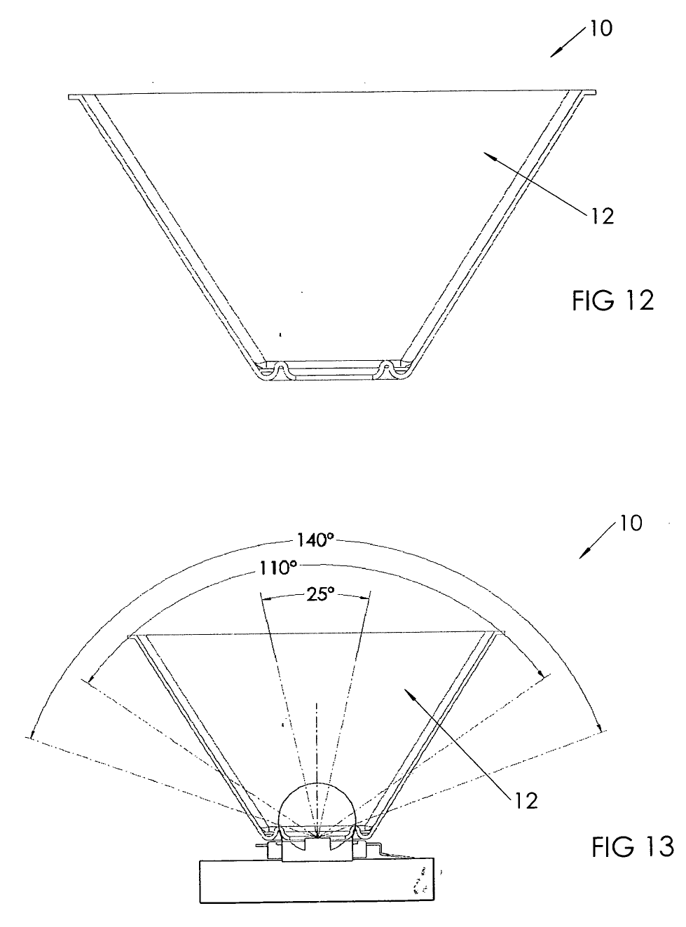

As illustrated in FIG. 12, a wave ring 22 can be formed on the bottom of the reflectors 12 allowing for material shrinkage without affecting reflectance ability. In this manner, the PET material can be molded into a reflector 12 having the desired shape for increasing light reflectance of the light emitting diodes. As illustrated in FIG. 13, a lambertian emitter is illustrated using the reflector 12 constructed in accordance with the present invention.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A reflector device for reflecting light from an LED and the like, the reflector device comprising:
a randomly disrupted surface reflectant material; and
a three-dimensional reflector formed from the reflectant material, the reflector having a top and a base, the reflector being entirely free from seams from the top to the base.

2. The reflector device of claim 1 and further comprising:
an aperture formed in the base;
wherein the LED is receivable within the aperture.

3. The reflector device of claim 2 wherein the reflector creates adjustable pressure and stress absorption preserving light seal areas around the LED.

4. The reflector device of claim 1 wherein the reflector has a continuous geometric shape.

5. The reflector device of claim 1 and further comprising:
material means for allowing for material shrinkage without affecting reflectance ability.

6. The reflector device of claim 5 wherein the material means is a wave ring formed in the base of the reflector.

7. The reflector device of claim 1 wherein the reflectors are attachable to other assembly components.

8. The reflector device of claim 1 wherein the reflector is constructed into the shape of a lambertian emitter.

9. A method for reflecting light from an LED and the like, the method comprising:
providing a reflectant material; and
forming a seamless three-dimensional reflector from the reflectant material, the reflector having a top and a base.

10. The method of claim 9 and further comprising:
forming aperture formed in the base; and
inserting the LED into the aperture.

11. The method of claim 10 and further comprising:
creating adjustable pressure and stress absorption preserving light seal areas around the LED.

12. The method of claim 9 and further comprising:
forming the reflector into a continuous geometric shape.

13. The method device of claim 9 and further comprising:
allowing for material shrinkage without affecting reflectance ability.

14. The method of claim 13 and further comprising:
forming a wave ring formed in the base of the reflector.

15. The method of claim 9 and further comprising:
attaching the reflectors to other assembly components.

16. The method of claim 9 and further comprising:
constructing the reflector into the shape of a lambertian emitter.

17. A reflector device for reflecting light from an LED and the like, the reflector device comprising:
a reflectant material;
a three-dimensional reflector formed from the reflectant material, the reflector having a top and a base, the reflector being entirely free from seams from the top to the base; and
an aperture formed in the base;
wherein the LED is receivable within the aperture.

18. The reflector device of claim 17 wherein the reflector creates adjustable pressure and stress absorption preserving light seal areas around the LED.

19. The reflector device of claim 17 wherein the reflector has a continuous geometric shape.

20. The reflector device of claim 17 and further comprising a wave ring formed in the base of the reflector.
